(19) United States
(12) Patent Application Publication
(10) Pub. No.: US 2025/0201075 A1
(43) Pub. Date: Jun. 19, 2025

(54) GAMING ESTABLISHMENT BENEFITS BASED ON A GAMING ESTABLISHMENT ACCOUNT MANAGEMENT SYSTEM INTEGRATED WITH A BANKING ACCOUNT

(71) Applicant: IGT, Las Vegas, NV (US)

(72) Inventors: Jeffery Shepherd, Reno, NV (US); Kevin Higgins, Reno, NV (US)

(21) Appl. No.: 18/541,417

(22) Filed: Dec. 15, 2023

(51) Int. Cl. G07F 17/32; G06Q 20/36; G06Q 40/02

(52) U.S. Cl. CPC G07F 17/3255; G06Q 20/36; G06Q 40/02

(57) ABSTRACT

Systems and methods that responsive to an authorized purchase transaction at a point-of-sale terminal using an amount of funds maintained in an integrated bank account associated with a user, determine a gaming establishment account associated with the user, and operate with a component of a gaming establishment system that maintains the gaming establishment account to cause, based on the authorized purchase transaction a benefit to be associated with the gaming establishment account.

### BACKGROUND

In various embodiments, responsive to an authorized purchase transaction at a point-of-sale terminal using an amount of funds maintained in an integrated bank account associated with a user, the systems and methods of the present disclosure determine a gaming establishment account associated with the user, and operate with a component of a gaming establishment system that maintains the gaming establishment account to cause, based on the authorized purchase transaction a benefit to be associated with the gaming establishment account.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF SUMMARY

In certain embodiments, the present disclosure relates to a system including a processor, and a memory device that stores a plurality of instructions. When executed by the processor responsive to a receipt, from a component of a banking institution, of data associated with an authorized purchase transaction at a point-of-sale terminal using an amount of funds maintained in an integrated bank account associated with a user, the instructions cause the processor to determine a gaming establishment account associated with the user, and communicate, to a component of a gaming establishment system that maintains the gaming establishment account, data associated with the authorized purchase transaction. The communicated data results in a benefit being associated with the gaming establishment account.

In certain embodiments, the present disclosure relates to a system including a processor, and a memory device that stores a plurality of instructions. When executed by the processor responsive to a receipt, from a component of a banking institution, of data associated with an authorized purchase transaction initiated in association with a debit card associated with a checking account linked to a gaming establishment account, the instructions cause the processor to determine a benefit associated with the authorized purchase transaction, and communicate, to a component of a gaming establishment system that maintains the gaming establishment account, data associated with the determined benefit.

In certain embodiments, the present disclosure relates to a method of operating a system. Responsive to a receipt, from a component of a banking institution, of data associated with an authorized purchase transaction at a point-of-sale terminal using an amount of funds maintained in an integrated bank account associated with a user, the method includes determining, by a processor, a gaming establishment account associated with the user, and communicating, to a component of a gaming establishment system that maintains the gaming establishment account, data associated with the authorized purchase transaction. The communicated data of the method of this embodiment results in a benefit being associated with the gaming establishment account.

Additional features are described herein, and will be apparent from the following Detailed Description and the figures.

### BRIEF DESCRIPTION OF THE SEVERAL VIEWS OF THE DRAWINGS

FIG. 1 is an example configuration of the architecture of a plurality of different components of the system of the present disclosure.

FIGS. 2A and 2B are example configurations of a plurality of different components employed in association with the present disclosure operating to create an integrated bank account on behalf of a user.

FIGS. 3A and 3B are example configurations of a plurality of different components employed in association with the present disclosure operating to apply one or more funding limits in association with an integrated bank account created on behalf of a user.

FIGS. 4A and 4B are example configurations of a plurality of different components employed in association with the present disclosure operating to transfer funds between an integrated bank account created on behalf of a user and a credit meter of an electronic gaming machine.

FIGS. 5A and 5B are example configurations of a plurality of different components employed in association with the present disclosure operating to reconcile fund transfers.

FIGS. 5C and 5D are example logs of transfers employed in the reconciliation of fund transfers.

### DETAILED DESCRIPTION

In various embodiments, responsive to an authorized purchase transaction at a point-of-sale terminal using an amount of funds maintained in an integrated bank account associated with a user, the systems and methods of the present disclosure determine a gaming establishment account associated with the user, and operate with a component of a gaming establishment system that maintains the gaming establishment account to cause, based on the authorized purchase transaction a benefit to be associated with the gaming establishment account.

In certain embodiments, the system of the present disclosure creates or otherwise integrates a bank account associated with a banking institution with one or more gaming establishment accounts maintained by a gaming establishment fund management system. The bank account, such as a checking account, is associated with the system of the present disclosure and operable to transfer funds to one or more gaming devices, such as one or more electronic gaming machines, of a gaming establishment. Additionally, the bank account, such as the checking account, is associated with a payment instrument, such as a debit card operable with a network payment processor, to enable financial transactions remote and independent from any gaming establishments. As such, the system of the present disclosure offers fund transfers between a gaming establishment fund management account maintained for a user (e.g., a user's cashless wagering account) and a dedicated bank account created for that user (e.g., a gaming checking account) and which is further associated with a payment instrument used in the banking industry to offer access to the funds associated with the dedicated bank account. Accordingly, the created (or otherwise integrated) bank account operates as a gateway to potentially access, in real time, funds that previously were maintained in a gaming establishment account and subject to various delays in the movement of such funds to and from the gaming establishment account.

In operation of certain embodiments, upon an enrollment event, such as a user requesting a creation of a gaming establishment patron management account (e.g., a gaming establishment player tracking account) and/or the user requesting a creation of a gaming establishment fund management account (e.g., a cashless wagering account), the system of the present disclosure operates with a banking institution to potentially create an integrated bank account (e.g., a checking account). In these embodiments, following a validation of the user as eligible to participate, the system interfaces with a component of a banking institution, such as a bank server, to create an integrated bank account that is dedicated to the user and associated with the system of the present disclosure.

In certain embodiments, such an integrated bank account is linked to a gaming establishment account associated with the user, such as a cashless wagering account, to facilitate the movement of funds within a gaming establishment environment via a gaming device interfacing with a component of the gaming establishment fund management system that maintains the gaming establishment account. For example, upon a user's request to transfer to an electronic gaming machine of a gaming establishment an amount of funds displayed as being held in a cashless wagering account maintained for that user (but actually held in an integrated bank account dedicated to that user), one or more components of the system operate to transfer the funds, without any external bank account transfer delays, from the integrated bank account to the electronic gaming machine. In this example, such a transfer occurs via an indirect transfer from the integrated bank account to the cashless wagering account maintained for the user and then to the electronic gaming machine or via a direct transfer, facilitated by a cashless wagering system that maintains the cashless wagering account, from the integrated bank account to the electronic gaming machine. In another example, upon a user cashing out an amount of funds from an electronic gaming machine of a gaming establishment (i.e., an occurrence of a funding event), one or more components of the system operate to transfer the funds to an integrated bank account such that the funds become available for use within the gaming establishment as well as outside of the gaming establishment. In this example, such a transfer occurs via an indirect transfer from the electronic gaming machine to a cashless wagering account maintained for that user and then to the integrated bank account or via a direct transfer, facilitated by a cashless wagering system that maintains the cashless wagering account, from the electronic gaming machine to the integrated bank account. It should be appreciated that in addition to transferring, directly or indirectly, funds between a gaming establishment account and an integrated bank account, since the gaming establishment account maintained for the user is associated with one or more backing bank accounts that hold at least a corresponding amount of funds as the funds attributed to the gaming establishment account, when funds move between the gaming establishment account and the integrated bank account, the system creates one or more ledgers of the existence of a debt between the sender of the funds and the receiver of the funds. In these embodiments, upon an occurrence of a settlement event, such as after a designated period of time (e.g., at the end of a day), the system reconciles such outstanding debt by initiating the transfer of funds between the appropriate bank accounts.

In certain embodiments, such an integrated bank account is further associated with one or more payment instruments, such as a debit card, an Automated Teller Machine (“ATM”) card, and/or one or more negotiable instruments (e.g., one or more checks, money orders and/or promissory notes), to facilitate the use of funds outside of the gaming establishment environment. As such, to provide a user instant access outside of a gaming establishment to funds that would otherwise reside in a gaming establishment account for gaming purposes, the system of the present disclosure creates and integrates a bank account with a gaming establishment account maintained for that user. Such a configuration enables funds to be accessed both at gaming establishment verticals and non-gaming establishment verticals without the need to wait for any extended periods of time for fund transfers from a gaming establishment account to an external financial institution account to be completed (or alternatively pay various surcharge fees to expedite such fund transfers).

It should be appreciated that unlike prior payment solutions in which if a user wants to access their funds held in a casino account at a retail establishment outside of the casino, the user needs to first transfer their funds to an external bank account (after which the user can then pay at that retail establishment outside of the casino using a debit card or credit card associated with their external bank account), or alternatively first transfer their funds to an external electronic wallet (after which the user can use a pre-paid debit card associated with their external electronic wallet to pay at that retail establishment outside of the casino), the creation of the integrated bank account in association with the system of the present disclosure enables a user to avail themselves of the use of a payment instrument, such as a debit card, for purchases made outside of the casino while still having funds readily available for use within the casino.

Accordingly, in certain embodiments, the system of the present disclosure enables the balance of the user's gaming establishment account to be transferred, upon a funding event, to an integrated bank account (that is dedicated to the user and remains owned by the system of the present disclosure) such that funds that previously were not immediately accessible outside of the casino become accessible via a payment instrument associated with the integrated bank account. In these embodiments, by associating a gaming establishment account maintained for a user, a created bank account dedicated to the user and linked to the gaming establishment account and an electronic wallet (e.g., a financial transaction application that runs on a mobile device and securely stores payment information, such as debit card information, and passwords to enable the payment of goods and/or services), the system of the present disclosure operates to enable funds to flow between different verticals quicker than previously available. In other words, by integrating a bank account created in association with the system directly with one or more gaming establishment accounts, the present disclosure enables a payment instrument associated with the integrated bank account to function as an interface to access funds independent of any involvement of any other external accounts that require a relatively extended period of time to transfer funds to. Such a configuration thus enables a user to access the network payment processors accessible with certain payment instruments, such as debit cards, without first needing to transfer any amounts of funds from a gaming establishment account to an external account associated with the debit card to gain such access. Such a configuration additionally saves users time (e.g., no time needs to be spent transferring funds from a gaming establishment account to an external banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

It should be further appreciated that unlike prior systems that required one or more inputs to transfer funds in a gaming establishment account to an external financial institution account associated with a debit card and further required a certain amount of time, such as up to three days, for the transfer to be completed and the transferred funds to become available for use using a debit card, the present disclosure bypasses these prolonged transfers (and in doing so further bypasses the need for the external financial institution account previously employed) and enables the system to interact, in real time, with various gaming establishment components and/or non-gaming establishment components such that the funds that otherwise would have to be maintained in a gaming establishment account (to enable such funds to be transferred to a gaming device) are available, via the employment of the integrated bank account, for immediate use at a gaming device (via interfacing with a gaming establishment fund management system) or at a non-gaming device (via employing a payment instrument associated with such an account as a gateway to such funds). As such, the system of the present disclosure offers the benefits of bank account transactions without the fund transfer friction and timing restrictions previously encountered in moving funds from a gaming establishment account, thereby providing the user greater control over their funds.

In addition to enabling funds held in an integrated bank account associated with a gaming establishment account to be freely used in gaming establishment transactions and non-gaming establishment transactions, the system of the present disclosure imposes zero, one or more limits on the integrated bank account. That is, since gaming establishment accounts, such as cashless wagering accounts, are subject to various regulations that bank accounts are not otherwise subject to and since the funds held in the created bank account of the present disclosure would, in certain instances, be used to fund gaming operations without the associated lag time of existing transfers between bank accounts and gaming establishment accounts, the system of the present disclosure employs zero, one or more gaming establishment account controls or limits to fund transfers involving the created bank account. For example, prior to completing a requested transfer of funds to a created bank account, the system determines if the bank account is in compliance with one or more deposit limits otherwise applicable to gaming establishment accounts. In this example, if the determination is that the transfer would violate one or more deposit limits (and/or the transfer is flagged by a component of one of the involved systems as a potential money laundering transaction), the system operates to deny the attempted transfer. On the other hand, if the determination is to complete the attempted transfer because such a transfer is in compliance with any applicable controls or limits, the system operates to complete the transaction and authorize, upon an occurrence of a settlement event, the transfers of funds between various accounts.

Accordingly, in view of the different channels of commerce available both in association with and independent of one or more gaming establishments, the system offers an integrated bank account created in association with the system that enables access to funds in different channels of commerce associated with or independent of one or more gaming establishments. Such transfers thus reduce the fund movement friction encountered in using funds otherwise held in a gaming establishment account to complete transactions outside of the gaming establishment network while still realizing the benefits of network payment processors offered by the use of payment instruments associated with the integrated bank account. Such a configuration further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

In various embodiments, the present disclosure is directed to a system, such as a gaming establishment fund management system, including various sub-systems that are each associated with or otherwise maintain one or more electronic or virtual accounts. In these embodiments, the various accounts maintained for a user individually or collectively form a resort or enterprise account (i.e., a gaming establishment fund management account) for the user. That is, the collection of cashless wagering accounts (e.g., cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a retail patron, individually or collectively form a resort or enterprise account (i.e., an integrated resort or gaming establishment fund management wallet) that the user may access to transfer funds and/or view balance information amongst the various accounts associated with or otherwise maintained for the user.

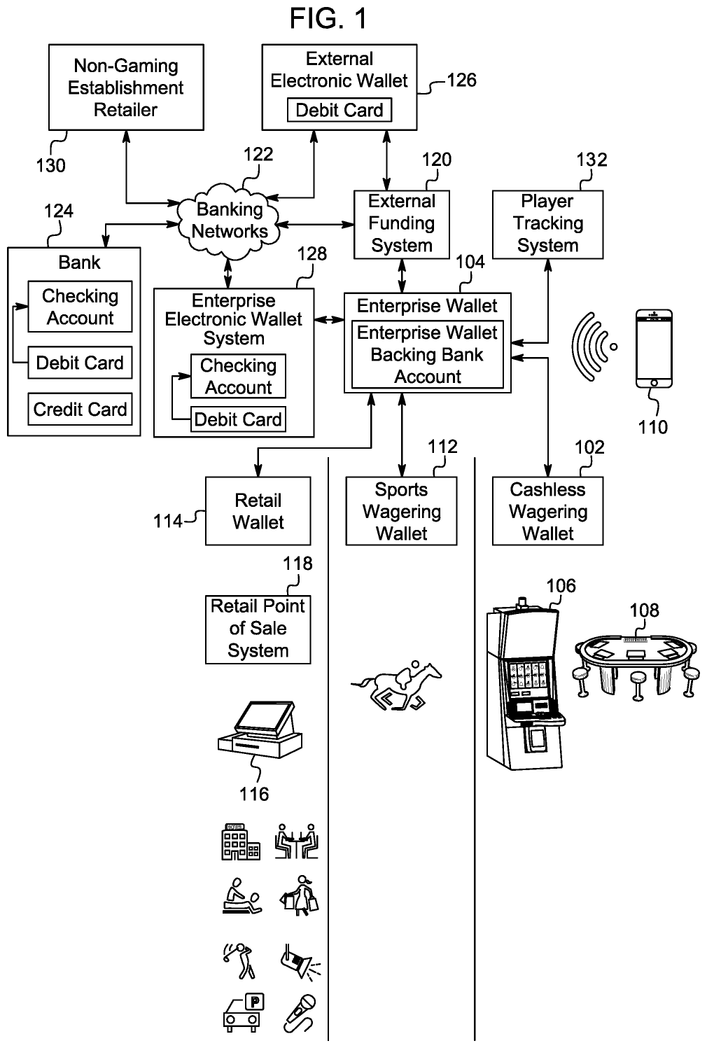

In various embodiments, the gaming establishment fund management system includes or is otherwise associated with one or more cashless wagering systems. Each cashless wagering system is associated with or otherwise maintain one or more cashless wagering accounts. In certain embodiments, the gaming establishment fund management system includes a first cashless wagering system that maintains a first cashless wagering account. In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a card reader associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. In certain embodiments, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a gaming establishment retailer to purchase goods and/or services from the gaming establishment retailer, the system utilizes a retail wallet identity, such as a mobile device 110 running a mobile device application that interfaces with a point-of-sale terminal 116 of a retail point-of-sale system 118 of the gaming establishment retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a gaming establishment retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, one or more of the accounts of the gaming establishment fund management system are associated with one or more backing bank accounts. In these embodiments, since certain regulations require that at least the funds held in association with one or more of the accounts of the gaming establishment fund management system be held in a financial institution account associated with the gaming establishment fund management system, the system of the present disclosure employs one or more of such backing bank accounts (to ensure compliance with applicable regulations) and further operates with one or more financial institutions to periodically reconcile the funds in such a backing bank account to reflect fund transfers associated with one or more accounts maintained by the gaming establishment fund management system. For example, as seen in FIG. 1, the enterprise wallet 104 maintained by the gaming establishment fund management system is associated with an enterprise wallet backing bank account that the gaming establishment fund management system operates with a component of a financial institution that maintains such a backing bank account to automatically move (or move responsive to commands from appropriate personnel) funds into and out of based on transactions made against the accounts maintained by the gaming establishment fund management system. It should be appreciated that while the enterprise wallet of this illustrated example is associated with an enterprise wallet backing bank account, any other account maintained by the system of the present disclosure, such as the illustrated first cashless wagering account, the illustrated second cashless wagering account and/or the illustrated gaming establishment retail account, may additionally or alternatively be associated with a backing bank account.

In certain embodiments, the gaming establishment fund management system includes or is otherwise in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking network 122) which operate to electronically transfer funds between the user's accounts maintained at such banks or financial institutions (i.e., bank 124 maintaining an external checking account associated with a debit card and/or a credit card) and one or more of the accounts maintained by the gaming establishment fund management system. As further seen in FIG. 1, in this example, the external funding system 120 is in communication (directly or indirectly via banking network 122) with an external electronic wallet 126 associated with a debit card, such as a pre-paid debit card, which operates to electronically transfer funds between the user's external electronic wallet and one or more of the accounts maintained by the gaming establishment fund management system. In certain embodiments, funds maintained in the accounts of the external funding sources may be transferred to and/or from one or more accounts maintained by the gaming establishment fund management system. These accounts of the external funding sources include, but are not limited to, one or more external checking accounts maintained by one or more financial institutions (e.g., one or more banks and/or credit unions), one or more external savings accounts maintained by one or more financial institutions, one or more external financial institution accounts, such as a brokerage account, maintained by one or more financial institutions, one or more external credit card accounts maintained by one or more financial institutions, one or more external debit card accounts maintained by one or more financial institutions, and/or one or more external third-party maintained accounts (e.g., one or more PayPal® accounts or Venmo® accounts). It should be appreciated that while illustrated as the gaming establishment fund management system being in communication with one or more external funding sources, in different embodiments, any system or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise associated with an enterprise electronic wallet system. In these embodiments, the enterprise electronic wallet system operates to open, be associated with or otherwise owns one or more integrated bank accounts on behalf of a user. In certain embodiments, the enterprise electronic wallet system opened bank account is associated with one or more debit cards for a user (which are independent of any debit cards associated with any external accounts maintained at any financial institution). Such a debit card operates to enable a user access to funds that may be transferred to a gaming device of a gaming establishment and/or used at one or more channels of commerce associated with the gaming establishment and/or independent of the gaming establishment. For example, as seen in FIG. 1, the gaming establishment fund management system that maintains the enterprise wallet 104 is in communication with an enterprise electronic wallet system 128 to facilitate the access of an amount of funds held a checking account opened by the enterprise electronic wallet system on behalf of a user and employing a debit card provided to the user. In this example, as also seen in FIG. 1, the network of one or more banks or other financial institutions (i.e., the banking network 122) is in communication with the enterprise electronic wallet system 128 to facilitate at least the settlement of funds held in the created accounts accessed via a debit card provided to the user. It should be appreciated that while illustrated as the gaming establishment fund management system being in communication with one or more enterprise electronic wallet systems, in different embodiments, any system or sub-system of the present disclosure can be in communication with one or more enterprise electronic wallet systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the enterprise electronic wallet system.

In certain embodiments, the enterprise electronic wallet system is associated with a single gaming establishment. In certain embodiments, the enterprise electronic wallet system is associated with a plurality of gaming establishments. In certain embodiments, the created integrated bank account is associated with a single gaming establishment. In these embodiments, a separate integrated bank account is created on behalf of each eligible user of each individual gaming establishment. In certain embodiments, the created integrated bank account is associated with a group of gaming establishments. In these embodiments, an integrated bank account is created on behalf of each eligible user of the group of a gaming establishments.

In certain instances, as explained in further detail below, the balance of one or more integrated bank accounts created by the enterprise electronic wallet system on behalf of a user are drawn down via transactions initiated by the provided payment instrument (e.g., debit card) and accessible at a point-of-sale-terminal external from any gaming establishment channel of commerce (e.g., a non-gaming establishment retailer 130 in communication, via the banking network 122). In certain instances, the balance of one or more integrated bank accounts created by the enterprise electronic wallet system on behalf of a user are additionally or alternatively drawn down via transactions accessible at a gaming device, such as an EGM 106 and/or a gaming table 108a. In certain instances, the balance of one or more integrated bank accounts created by the enterprise electronic wallet system on behalf of a user are drawn down via transactions accessible at a point-of-sale terminal 116 within a gaming establishment channel of commerce.

In certain embodiments, the gaming establishment fund management system is in communication with one or more gaming establishment patron management systems (e.g., player tracking system 132) that monitor activities at various points of contact associated with the gaming establishment and provides rewards, such as redeemable player tracking points, in association with such activities. It should be appreciated that while, in certain embodiments, the gaming establishment fund management system is in communication with one or more gaming establishment patron management systems, in different embodiments, any system or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments (not shown), the gaming establishment fund management system is in communication with one or more credit systems which each issue the user one or more lines of credit. These lines of credit are accessible to facilitate a transfer of funds from the line of credit issued by the credit system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal). It should be appreciated that the gaming establishment fund management system may be in communication with one or more credit systems, and in different embodiments, any system or sub-system of the present disclosure can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments (not shown), the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any system or sub-system of the present disclosure can be in communication with one or more credit reporting/credit risk systems.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, a gaming device (e.g., an interface of an EGM or gaming table component), a service window displayed by a gaming establishment device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account) as mentioned above, a physical instrument, such as a smart card or a user issued magnetic striped card may additionally or alternatively be utilized to enable a user access to such gaming establishment account.

In certain embodiments, the system enables a transfer of funds between different accounts maintained by different components associated with different gaming activities and/or non-gaming activities. In these embodiments, the system employs a service for interfacing with the various components to facilitate balance inquiry and transferring funds amongst the different accounts maintained by these various components. In certain embodiments, such a service collects data from various components and utilizes such collected data to provide a singular view of the balances (or a plurality of singular views of different groupings of balances). In certain embodiments, such a service additionally or alternatively provides facilities to enforce rules associated with the different accounts maintained by the various components. In different such embodiments, these rules include, but are not limited to, jurisdictional controls, self-imposed limits, state governmental controls and federal governmental controls, wherein the system provides the logic to determine how, and how much, to transfer from each account of the various interconnected components to satisfy a request for funds while staying within the confines of such rules. In certain embodiments, such a service additionally or alternatively tracks and coalesces transaction history across the accounts of the interconnected components of the system. In these embodiments, all transactions within the system have a “master” transaction record that ties all of the various fund transfers to a single initiating funds transfer regardless of how many accounts were withdrawn to the satisfy the original request.

In various embodiments, prior to enabling a user to transfer funds in an integrated bank account created by the system on behalf of a user to a gaming device and/or utilize such funds to purchase goods and/or services using a debit card associated with that integrated bank account, the system must first open such an account (if needed).

In certain embodiments, the system creates the integrated bank account on behalf of a user when the user creates a gaming establishment account, such as a cashless wagering account, a gaming establishment retail account and/or a gaming establishment patron management system account (e.g., a player tracking account). In these embodiments, via interacting with one or more touchpoints, such as a mobile device application being executed by a mobile device, a kiosk, a point-of-sale terminal, an EGM, a casino cage, and/or a website accessed from a browser, the user attempts to open a gaming establishment account through one or more interactive forms. For example, as part of opening a cashless wagering account, a user makes one or more inputs via an interface to provide certain user identifying information, such as, but not limited to, a full legal name, mother's maiden name, an address, a country of residence, a country of citizenship, a birthday (including birth location), contact information (e.g., phone number, email), a government issued identification card, a government issued driver's license, a government issued passport, a government issued social security number, a portion of a government issued social security number (e.g., the last four digits), income information (e.g., credit card information, debit card information, bank account information), biometric data (e.g., finger print, signature, or photo), or other such information.

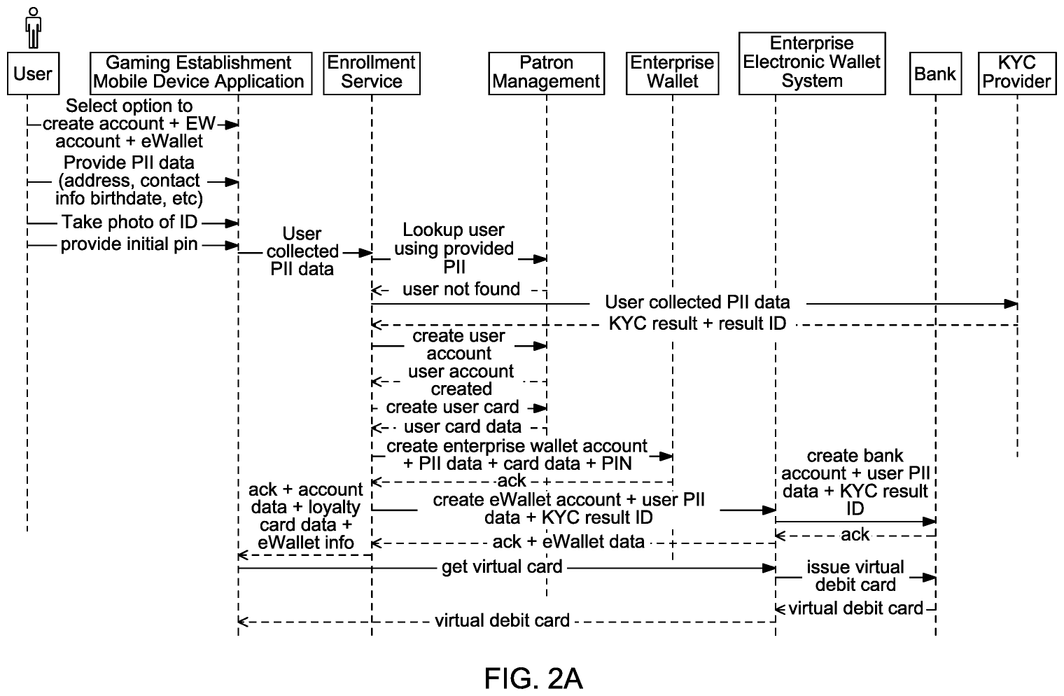

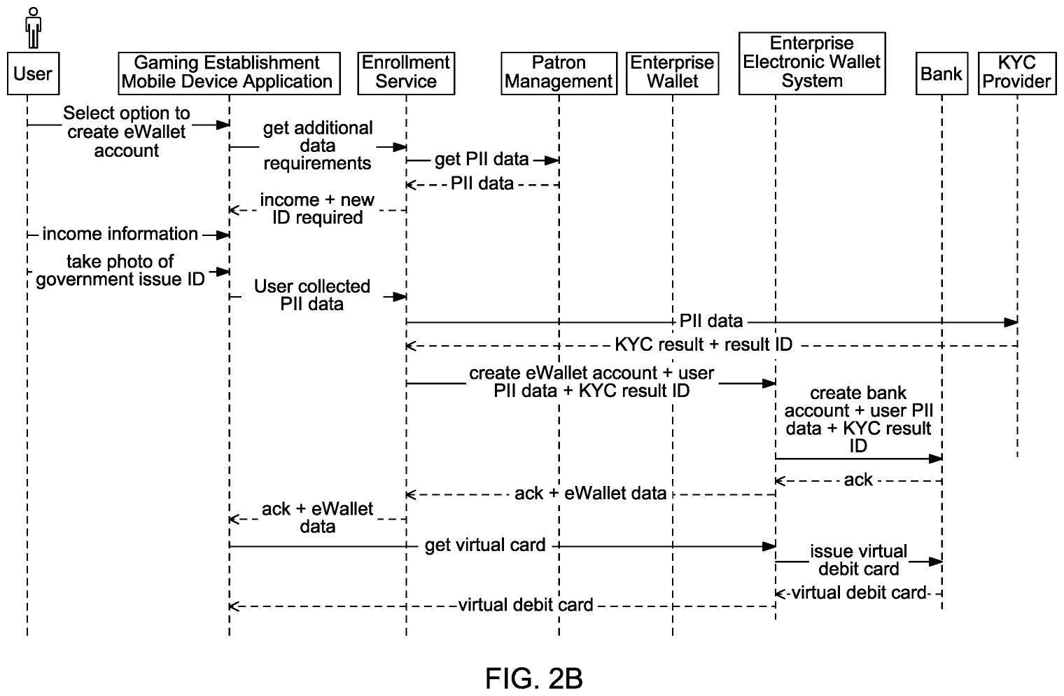

In these embodiments, following such information being made available by the user, the system utilizes part or all of such identifying information to operate with a financial institution to perform one or more Know Your Customer (“KYC”) checks to validate the information and if so, create an integrated bank account on behalf of the user. For example, as seen in FIG. 2A (which illustrates the described interactions between the user, various components of the system of the present disclosure, a financial institution (e.g., a bank) and a KYC service provider), certain embodiments enable the creation of an integrated bank account on behalf of a user as part of that user's enrollment in a gaming establishment account.

In certain embodiments, the system creates the integrated bank account on behalf of a user in association a previously created gaming establishment account, such as a cashless wagering account a gaming establishment retail account and/or a gaming establishment patron management system account (e.g., a player tracking account). In these embodiments, since certain identifying information was previously provided in association with the opening of the existing gaming establishment account, the system requires less information to be provided, such as information needed to open the integrated bank account that was not already collected (e.g., income information, a government issued identification card, a government issued driver's license, and/or a government issued passport). As such, this creation of the integrated bank account reduces time spent by the user because the user does not need to provide certain additional information for the system to create the integrated bank account. In these embodiments, the system utilizes part or all of the previously provided information as well as part or all of the additional identifying information to operate with a financial institution to perform one or more KYC checks to validate the information and if so, create an integrated bank account on behalf of the user. For example, as seen in FIG. 2B (which illustrates the described interactions between the user, various components of the system of the present disclosure, a financial institution (e.g., a bank) and a KYC service provider), certain embodiments enable the creation of an integrated bank account on behalf of a user based on information previously obtained in association with an existing gaming establishment account.

In certain embodiments, during creation of the integrated bank account on behalf of the user, the system requires the user to acknowledge a set of rules associated with the integrated bank account by providing a signature or other such indication that the user has read and agrees to the set of rules associated with the integrated bank account. For example, the set of rules of the account includes, but is not limited to: limits of the integrated bank account, authorized users of the integrated bank account, and/or acceptable funding sources of the integrated bank account.

In certain embodiments, in association with creating an integrated bank account on behalf of a user, the system provides the user a payment instrument, such as a debit card, to use for certain purchase transactions. In one such embodiment, the payment instrument, such as a debit card, takes the form of a physical instrument (e.g., a smart card that stores information or a magnetic striped debit card that stores information). In another such embodiment, the payment instrument, such as a debit card, additionally or alternatively takes the form of a virtual instrument (e.g., a mobile device application and/or a component of a mobile device operating system that stores account information and is operable with a point-of-sale terminal). In one such embodiment, information associated with the virtual debit card is communicated from the financial institution to a gaming establishment mobile device application running on the user's mobile device. In another such embodiment, information associated with the virtual debit card is communicated from the financial institution to the user's mobile device to be stored in a wallet application being run on the user's mobile device.

In certain embodiments, following the creation of an integrated bank account on behalf of a user, the system enables the user to fund the integrated bank account. In certain embodiments, the system enables the user to fund the integrated bank account using one or more bank account transfers (e.g., an automated clearing house (“ACIT”) transfer), a guaranteed ACH transfer, and/or an electronic check (“eCheck”) transfer). In certain embodiments, the system enables the user to fund the created integrated bank account using one or more of a transfer based on credit card information, a transfer based on external debit card information, a transfer based on a third-party maintained account (e.g., one or more PayPal® accounts or Venmo® accounts). In certain embodiments, the system enables the user to fund the created integrated bank account using a mobile device electronic fund transfer, such as using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account to the integrated bank account.

In certain embodiments, the system enables funds to be deposited in a created integrated bank account via activating a line of credit associated with the user. In certain embodiments, the system enables funds to be deposited in a created integrated bank account, via a gaming device, such as an EGM and/or via a non-gaming device, such as a kiosk. In certain embodiments, the system enables a user that has an amount of cash to utilize a gaming device and/or a non-gaming device to convert the cash to an amount deposited into a created integrated bank account. In certain embodiments, the system enables funds to be deposited in a created integrated bank account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a created integrated bank account.

In certain embodiments, the system enables funds to be deposited in a created integrated bank account via a gaming device and/or a non-gaming device that accepts printed ticket vouchers. In these embodiments, the system enables a user that has one or more printed ticket vouchers to utilize a gaming device and/or a non-gaming device to convert the printed ticket voucher to an amount deposited into a created integrated bank account. In other embodiments, the system enables funds to be deposited in a created integrated bank account via a gaming establishment interface that accepts printed ticket vouchers. In these embodiments, the system enables a user that has one or more printed ticket vouchers to utilize a gaming establishment interface to convert the printed ticket voucher to an amount deposited into a created integrated bank account. In certain embodiments, the created integrated bank account is associated with funds associated with one or more virtual ticket vouchers. In certain embodiments, the system enables a user associated with an amount of virtual ticket vouchers to utilize a gaming device (e.g., an EGM, or a component of an EGM), a non-gaming device (e.g., a kiosk), a mobile device running a mobile device application, and/or a gaming establishment interface to convert the virtual ticket vouchers to an amount deposited into a created integrated bank account.

In certain embodiments, as part of creating an integrated bank account on behalf of the user, the gaming establishment fund management system and/or the enterprise electronic wallet system determines zero, one or more security measures to invoke in association with one or more transactions against the integrated bank account. In these embodiments, to prevent unauthorized access to funds associated with the integrated bank account, the system applies such determined security measures in association with attempted transactions against the integrated bank account.

In certain embodiments, as part of creating an integrated bank account on behalf of a user, the gaming establishment fund management system and/or the enterprise electronic wallet system determines one or more controls or restrictions, such as use limits, to associate with the integrated bank account wherein if such conditions are satisfied, the gaming establishment fund management system and/or the enterprise electronic wallet system denies the transaction or invokes one or more security measures. In these embodiments, to balance the need to prevent unauthorized access to the funds associated with the integrated bank account against the need to provide a frictionless experience for users, the gaming establishment fund management system and/or the enterprise electronic wallet system dynamically employs one or more controls such that certain transactions trigger the need to potentially employ enhanced security measures and certain transactions do not trigger the need to potentially employ enhanced security measures.

It should be appreciated while certain jurisdictions supports various types of limits on funds associated with gaming establishment accounts (e.g., certain Nevada regulations require deposit limits on each instrument used to fund an account and other Nevada regulations require a cashless wagering account to enable a user to set a deposit limit over a desired period of time), such limits associated with gaming establishment accounts are different from limits associated with financial institution accounts. Accordingly, if the funding of a gaming establishment account of a user, such as a cashless wagering account, effectively occurs as funding of an integrated bank account created on behalf of the user, then the gaming establishment fund management system and/or the enterprise electronic wallet system will implement certain required limits (i.e., integrated bank account usage controls) because the gaming establishment account, such as the cashless wagering account, is not otherwise directly exposed to the entirety of the funding/deposit operations. As explained below, in different embodiments, these limits are applicable per account, per payment instrument, per unit of time and/or per transaction.

In certain embodiments, the integrated bank account usage controls are associated with an amount of funds deposited in an integrated bank account created on behalf of the user over a given period of time (e.g., hourly, daily, weekly, monthly). For example, the gaming establishment fund management system and/or the enterprise electronic wallet system places a $10000 per day limit on deposits of funds to an integrated bank account created on behalf of the user. In these embodiments, such integrated bank account usage controls pertain to the frequency of depositing funds in an integrated bank account created on behalf of the user and/or the amounts deposited. In certain embodiments, these integrated bank account usage controls and/or security measures are applicable for each of the funding sources available to deposit funds in an integrated bank account created on behalf of the user. In certain other embodiments, these integrated bank account usage controls and/or security measures are applicable for certain of, but not each of, the funding sources available to deposit funds in an integrated bank account created on behalf of the user. For example, these integrated bank account usage controls and/or security measures are applicable for funding from banking sources, but not applicable for funding from other sources (which may separate usage controls and/or security measures in place).

In certain embodiments, the integrated bank account usage controls are associated with an amount of funds withdrawn from an integrated bank account created on behalf of the user over a given period of time (e.g., hourly, daily, weekly, monthly). For example, the gaming establishment fund management system and/or the enterprise electronic wallet system places a $10000 per day limit on withdrawals of funds from an integrated bank account created on behalf of the user. In these embodiments, such integrated bank account usage controls pertain to the frequency of withdrawing funds from an integrated bank account created on behalf of the user and/or the amounts accessed. In certain embodiments, these integrated bank account usage controls and/or security measures are applicable for each of the destinations of funds from an integrated bank account created on behalf of the user. In certain other embodiments, these integrated bank account usage controls and/or security measures are applicable for certain of, but not each of, the destinations of funds from an integrated bank account created on behalf of the user. For example, these integrated bank account usage controls and/or security measures are applicable for transfers to non-banking sources, but not applicable for transfers to banking sources (which may separate usage controls and/or security measures in place).

In certain embodiments, the integrated bank account usage controls are associated with a quantity and/or an amount of transactions involving funds maintained in an integrated bank account created on behalf of the user over a given period of time (e.g., hourly, daily, weekly, monthly). For example, the gaming establishment fund management system and/or the enterprise electronic wallet system places a $2000 per day limit on purchases made using funds in an integrated bank account created on behalf of the user. In these embodiments, such integrated bank account usage controls pertain to the frequency of accessing funds in an integrated bank account created on behalf of the user and/or the amounts accessed.

In certain embodiments, the integrated bank account usage controls are additionally or alternatively associated with the amount of a transaction involving funds maintained in an integrated bank account created on behalf of the user. In these embodiments, certain retail purchases having a value above a threshold value that trigger the use of one or more integrated bank account usage controls while other retail purchases that have a value below the threshold value do not trigger such integrated bank account usage controls.

In certain embodiments, the integrated bank account usage controls are associated with an identity of whom may initiate a transaction involving funds maintained in an integrated bank account created on behalf of the user. For example, the gaming establishment fund management system and/or the enterprise electronic wallet system determines that a user enrolled in player tracking system who qualifies as a bronze status member may spend up to $500 on purchases made using funds in an integrated bank account created on behalf of that user, while another user who qualifies as a platinum status member may spend up to $20,000 on purchases made using a funds in an integrated bank account created on behalf of that user. In certain such embodiments, one or more activities of the identified user may factor into the employment (or lack thereof) or integrated bank account usage controls. For example, the gaming establishment fund management system and/or the enterprise electronic wallet system adjusts a limit amount based on one or more of, has the user gambled or started a gaming session recently (e.g., last day, last hour), has the user won at a gaming establishment (and if so, the amount of those winnings), and/or is the user checked into the hotel of the gaming establishment.

In certain embodiments, the integrated bank account usage controls are associated with an identity of the retailer associated with a transaction involving funds maintained in an integrated bank account created on behalf of the user. In these embodiments, the gaming establishment fund management system and/or the enterprise electronic wallet system imposes, using a Merchant Category Code (MCC) or a white list or blacklist of retailers, integrated bank account usage controls on a type of industry or retailer thus eliminating an entire class of retailers from participating in the commerce.

In certain embodiments, the integrated bank account usage controls are additionally or alternatively associated with the type of good and/or service associated with the transaction involving funds maintained in an integrated bank account created on behalf of the user. In these embodiments, certain types of retail purchases trigger the use of one or more integrated bank account usage controls while other types of retail purchases do not trigger such integrated bank account usage controls. For example, a first category of purchases, such as food and beverage purchases, can be made using funds from an integrated bank account without triggering any integrated bank account usage controls while a second category of purchases, such as clothing retail outlets and entertainment related charges, triggers one or more integrated bank account usage controls that must be satisfied before the completion of such purchases with funds from an integrated bank account.

In certain embodiments, the integrated bank account usage controls are additionally or alternatively associated with a location of the retail purchase attempted to be made involving funds maintained in an integrated bank account created on behalf of the user. In these embodiments, different locations where the funds from the integrated bank account may be used are associated with different integrated bank account usage controls required to use such funds. For example, a transaction involving funds maintained in an integrated bank account created on behalf of the user attempted in association with a first location within a gaming establishment do not trigger the use of one or more integrated bank account usage controls while a transaction, involving funds maintained in an integrated bank account created on behalf of the user attempted in association with a second location external from the gaming establishment trigger one or more integrated bank account usage controls. In this example, different gaming establishment affiliated partner locations may trigger different integrated bank account usage controls than different non-gaming establishment affiliated partner locations.

In certain embodiments, the integrated bank account usage controls are additionally or alternatively associated with a channel of commerce in which the transaction involving funds maintained in an integrated bank account created on behalf of the user is attempted to be made. In these embodiments, different channels of commerce (in certain instances determined via the merchant identifier of the retail establishment) where the funds from the integrated bank account may be accessed are associated with different integrated bank account usage controls required to use such funds. In certain embodiments, the integrated bank account usage controls are additionally or alternatively associated with a time of when the transaction is attempted to be made. In certain embodiments, the integrated bank account usage controls are additionally or alternatively associated with an amount of funds currently maintained in an integrated bank account associated with a user. In certain embodiments, the integrated bank account usage controls are additionally or alternatively associated with a current rate of consumption of the funds in one or more integrated bank accounts maintained for the user. In one such embodiment, the rate of consumption is based on an amount of transactions made using funds from an integrated bank account over a set period of time, such as the current day. In another such embodiment, the rate of consumption is based on an amount of transactions made using funds from an integrated bank account over a rolling period of time, such as the past 24 hours.

It should be appreciated that in different embodiments, the system employs a combination of these integrated bank account usage controls to determine whether or not a transaction involving funds maintained in an integrated bank account created on behalf of the user is permitted and/or any security measures need to be activated. For example, integrated bank account usage controls are based on whether a total amount of retail purchases made at a designated location on certain type of goods and/or services using funds from an integrated bank account are over a designated period of time. In this example, if the total amount of retail purchases made at the designated location on the identified type of goods and/or services using funds from the integrated bank account over the designated period of time meet or exceed a threshold, then the system denies the authorization of subsequent transactions and/or employs one or more enhanced security features.

In certain embodiments, the system enables an operator, such as a gaming establishment operator, to determine and activate zero, one or more integrated bank account usage controls to associate with an integrated bank account as well as zero, one or more security measures to employ. In these embodiments, if any operator determined integrated bank account usage controls are violated, the system attempts to prevent unauthorized access to the funds associated with the integrated bank account. In certain embodiments, the determination to associate one or more integrated bank account usage controls and/or security measures is based on one or more inputs from an operator wherein personnel, such as gaming establishment personnel indicate that they would like one or more integrated bank account usage controls and/or security measures associated with certain of (or each of) the transactions using funds from the integrated bank account.

In certain embodiments, the system enables a retail point-of-sale system to determine and activate one or more integrated bank account usage controls and/or security measures to associate with transactions undertaken by the retail point-of-sale system. In certain of these embodiments, the determination to associate one or more integrated bank account usage controls and/or security measures is based on one or more inputs from retail personnel whom indicate that they would like one or more integrated bank account usage controls and/or security measures associated with certain of (or each of) the purchases made in association with the retail point-of-sale system. In certain other of these embodiments, the determination to associate one or more integrated bank account usage controls and/or security measures is based on one or more settings associated with the retail point-of-sale system that dictate one or more integrated bank account usage controls and/or security measures associated with certain of (or each of) the purchases made in association with the retail point-of-sale system. In certain embodiments, one or more determinations are made at the retail point-of-sale terminal level wherein different terminals are associated with different integrated bank account usage controls and/or security measures. In certain embodiments, one or more determinations are made at the retail point-of-sale system level wherein each terminal is associated with the same integrated bank account usage controls and/or security measures (which, as described below, may vary based on one or more attributes of the attempted transaction).

In certain embodiments, the system enables the user to determine and activate zero, one or more integrated bank account usage controls to associate with the integrated bank account as well as zero, one or more security measures to employ. In these embodiments, if any user determined integrated bank account usage controls are violated, the system attempts to prevent unauthorized access to the funds associated with the integrated bank account. In certain embodiments, the determination to associate one or more integrated bank account usage controls and/or security measures is based on one or more inputs from the user wherein the user indicates that they would like one or more integrated bank account usage controls and/or security measures associated with certain of (or each of) the purchases made using funds from the integrated bank account created on behalf of the user. For example, the user sets an integrated bank account usage limit for a set period of time, such as a calendar day, a set quantity of hours (e.g., 24 hours), and/or a period of time that aligns with a user's work pay period.

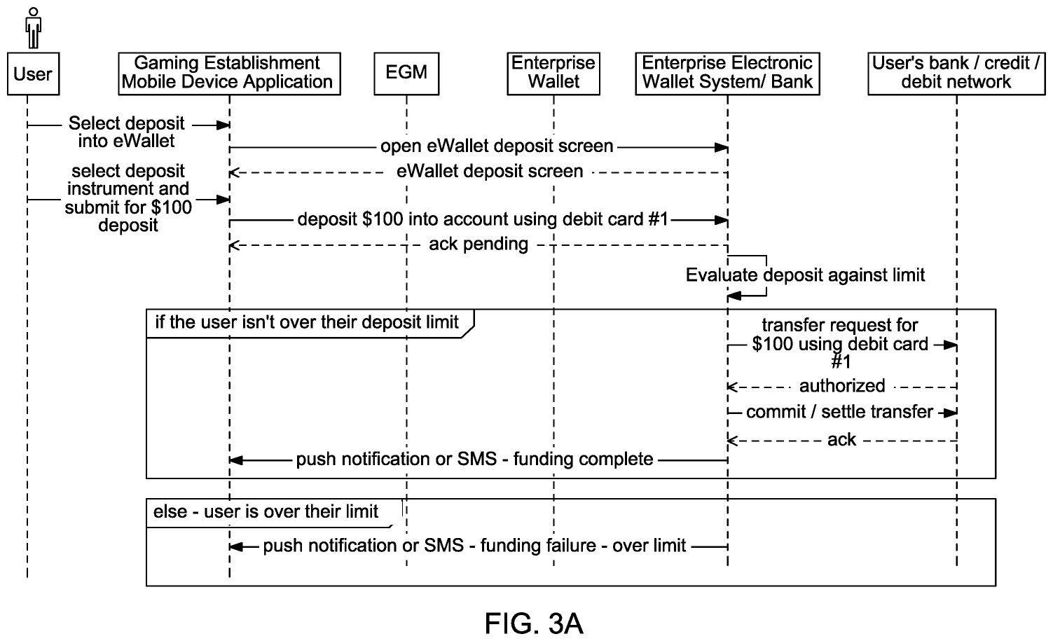

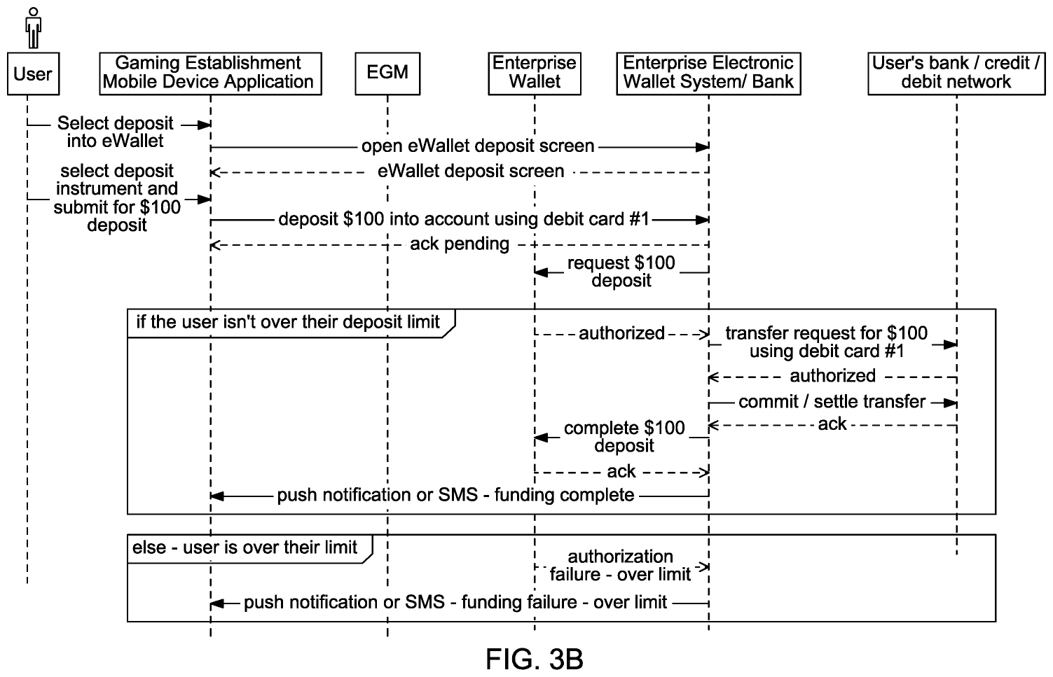

In certain embodiments, the enterprise electronic wallet system implements one or more integrated bank account usage controls and/or security measures. In these embodiments, the enterprise electronic wallet system is tasked with monitoring activity of the integrated bank account created on behalf of the user, such as funding transactions, and accepting or rejecting such activity based on the currently configured limits associated with the integrated bank account relative to certain prior activity, if any, during an applicable period of time. For example, as seen in FIG. 3A (which illustrates the described interactions between the user, various components of the system of the present disclosure, and a financial institution of the user (e.g., a bank)), certain embodiments enable the enterprise electronic wallet system to determine whether a funding transaction of an integrated bank account created on behalf of a user complies with one or more limits and accept or reject the funding transaction based on such a determination. In this example, based on the compliance (or lack thereof) of one or more deposit limits imposed on the integrated bank account created by the enterprise electronic wallet system, the enterprise electronic wallet system notifies the user of a status of the attempted deposit of funds into the integrated bank account via a message displayed at any suitable device, via an email, via an SMS or text message, and/or via a notification displayed by a mobile device application.

In certain embodiments, the gaming establishment fund management system implements one or more integrated bank account usage controls and/or security measures. In these embodiments, the gaming establishment fund management system is tasked with monitoring activity of the integrated bank account created on behalf of the user, such as funding transactions, and accepting or rejecting such activity based on the currently configured limits associated with the integrated bank account relative to certain prior activity, if any, during an applicable period of time. For example, as seen in FIG. 3B (which illustrates the described interactions between the user, various components of the system of the present disclosure, and a financial institution of the user (e.g., a bank)), certain embodiments enable the gaming establishment fund management system to determine whether a funding transaction of an integrated bank account created on behalf of a user complies with one or more limits and accept or reject the funding transaction based on such a determination. In this example, based on the compliance (or lack thereof) of one or more deposit limits imposed on the integrated bank account created by the enterprise electronic wallet system, the gaming establishment fund management system notifies the user of a status of the attempted deposit of funds into the integrated bank account via a message displayed at any suitable device, via an email, via an SMS or text message, and/or via a notification displayed by a mobile device application. In certain instances, since the gaming establishment fund management system has visibility into other types of deposit transactions, such as cash deposited into various gaming establishment verticals (e.g., cash deposited into an EGM or a kiosk), if the deposit limit needs to take account for these other types of deposit transactions, the gaming establishment fund management system is relatively better situated to impose certain limits.

It should be appreciated that in certain embodiments, since the ability to make retail purchases with funds deposited into an integrated bank account created on behalf of the user creates potential money laundering risks (e.g., a user could solely fund their account using illicit cash at an EGM, then transfer those funds back to their account and later use such funds to buy luxury goods or services from a retailer and/or a user could transfer illicit funds electronically into their account and then use such funds to make a purchase at a luxury retailer), the system of the present disclosure detects these scenarios, and potentially blocks them and/or reports them by providing the appropriate information that must be filed with financial crimes regulators in a given jurisdiction. In one such embodiment, the gaming establishment fund management system and/or enterprise electronic wallet system prevents a user from making a purchase using funds in an integrated bank account created on behalf of the user if the funds transferred or deposited into the account have not been transferred to an EGM and/or a gambling touchpoint on a gaming establishment floor. In another such embodiment, the gaming establishment fund management system and/or enterprise electronic wallet system tracks funds that were deposited into an EGM (via cash or an instrument unaffiliated with a user, such as a ticket voucher) but were not wagered. In this embodiment, upon receipt of this information (that is, some transfer of funds into the integrated bank account), the system restricts or prevents the user to make a purchase using such funds until those funds have been wagered with. In certain additional or alternative embodiments, one or more components of the gaming establishment fund management system and/or enterprise electronic wallet system reports on user attempts to make purchases using funds that have not been wagered. In one such embodiment, the system generates reports of all attempted retail purchases using funds in an integrated bank account created on behalf of the user that have not been wagered over a defined lookback period. Such an embodiment enables gaming establishment personnel the ability to have the appropriate information to file one or more suspicious activity reports with financial crimes regulatory agencies, such as the US Treasury's FinCEN. In another such embodiment, upon detection of a suspicious financial transaction event, the system automatically fills in the appropriate regulatory agency report (e.g., Suspicious Activity Report (SAR), Currency Transaction Report (CTR)) for submission by the gaming establishment to the regulatory body. In another such embodiment, the system electronically submits the generated reports to the appropriate regulatory body.

In certain embodiments, the system employs the same integrated bank account usage controls and/or security measures for each user whom attempts to transact against an integrated bank account created on behalf of the user. In certain embodiments, the system employs different integrated bank account usage controls and/or security measures for different users whom attempt to transact against an integrated bank account created on behalf of the user. In certain of these embodiments, the system utilizes historical data regarding the user and past transactions in determining one or more aspects of one or more integrated bank account usage controls and/or security measures to associate with that user. In certain of these embodiments, the system utilizes one or more attributes of the user, such as a player tracking account status of the user, in determining one or more aspects of one or more integrated bank account usage controls and/or security measures to associate with that user.

It should be appreciated that in certain embodiments, one or more of the integrated bank account usage controls may be overridden and/or adjusted by qualifying personnel, such as gaming establishment personnel. In these embodiments, the gaming establishment fund management system and/or the enterprise electronic wallet system associates different levels of overriding and/or adjusting of integrated bank account usage controls with different qualifying personnel. In these embodiments, the gaming establishment fund management system and/or the enterprise electronic wallet system enables different levels of overriding and/or adjusting of integrated bank account usage controls for different users based on one or more attributes, such as status or historical spend, of such users.

In certain embodiments, following the creation of an integrated bank account on behalf of a user, the issuance of one or more payment instruments, such as debit cards, associated with the integrated bank account, and the deposit of funds into the integrated bank account (subject to zero, one or more applicable controls and/or enhanced security measures), the system enables the user to access to funds in such an integrated bank account.

In certain embodiments, the system enables a user to transfer funds from an integrated bank account created on behalf of the user to/from an EGM in association with one or more components of the gaming establishment fund management system, such as a component of a cashless wagering system. In these embodiments, the gaming establishment fund management system operates with the enterprise electronic wallet system (that created the integrated bank account created on behalf of the user) to facilitate the transfer of funds to one or more destinations.

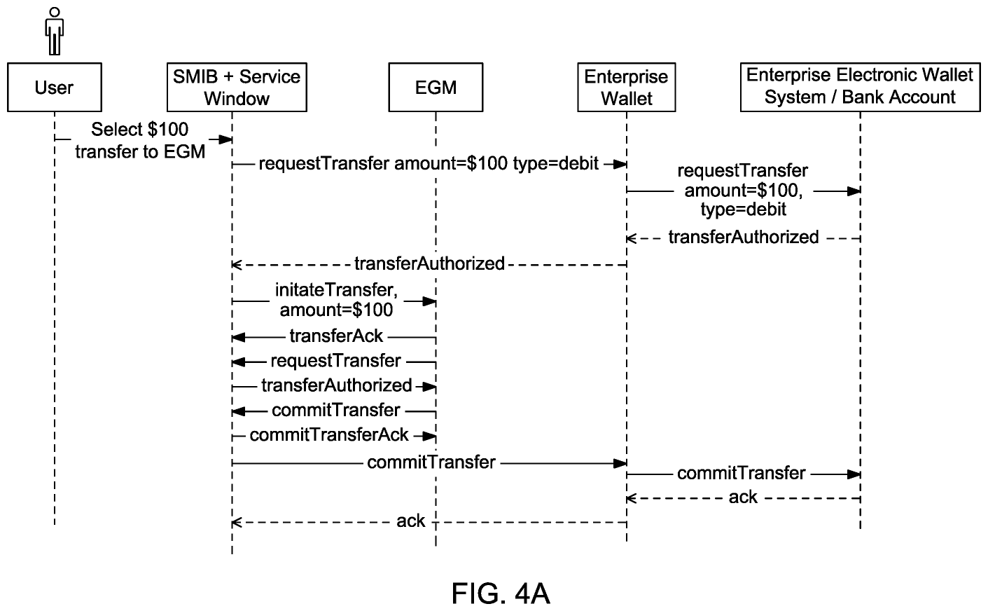

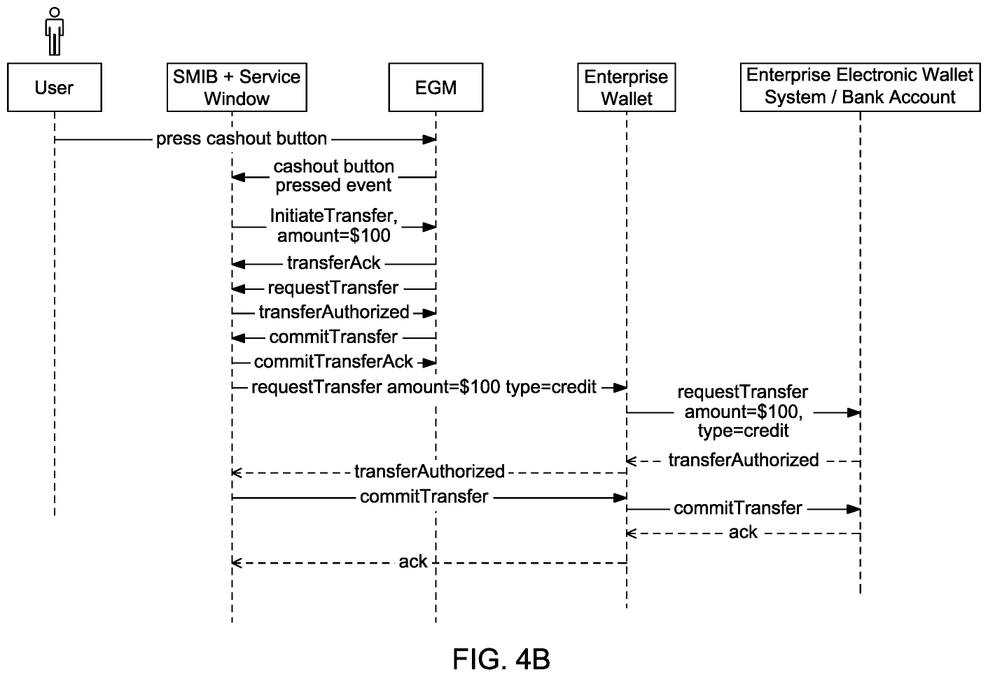

In certain embodiments, the user interfaces with one or more components associated with the gaming establishment fund management system to transfer an amount of funds to the EGM and the gaming establishment fund management system interfaces with the enterprise electronic wallet system to potentially complete the transfer of funds from the integrated bank account created on behalf of the user to the EGM. In these embodiments, responsive to the user indicating an amount of funds to transfer to the EGM, the gaming establishment fund management system initiates a requested transfer of funds from the integrated bank account to the EGM. That is, responsive to a user requesting a transfer of funds to an EGM, one or more components of a gaming establishment fund management system operate with one or more components that maintains the integrated bank account created on behalf of the user to potentially complete the transfer. In these embodiments, subject to the transfer being approved (and the applicability of zero, one or more usage controls and/or security measures), the one or more components of the gaming establishment fund management system transfer (or otherwise approve a transfer for subsequent settlement upon an occurrence of a settlement event) an amount of funds to the EGM from the integrated bank account created for the user. For example, as seen in FIG. 4A (which illustrates the described interactions between the user interfacing with a component of the gaming establishment fund management system (e.g., a slot machine interface board (“SMIB”) accessible via a service window), the EGM, the gaming establishment fund management system (e.g., the enterprise wallet) and the component that created the integrated bank account on behalf of the user (e.g., the enterprise electronic wallet system), certain embodiments of the present disclosure employ the gaming establishment fund management system to facilitate the transfer of funds from the integrated bank account created on behalf of the user to the EGM.

In certain embodiments, the user interfaces with one or more components associated with the gaming establishment fund management system to transfer an amount of funds from the EGM. In such embodiments, the gaming establishment fund management system interfaces with the enterprise electronic wallet system to potentially complete the transfer of funds to the integrated bank account created on behalf of the user to the EGM. In these embodiments, responsive to the user requesting, via a cashout request coupled with designating a fund destination, to transfer an amount of funds from the EGM, the gaming establishment fund management system initiates a requested transfer of funds from the EGM to the integrated bank account created on behalf of the user. In such embodiments, responsive to a user requesting a transfer of funds from an EGM (and the applicability of zero, one or more usage controls and/or security measures), one or more components of a gaming establishment fund management system operate with one or more components that maintains the integrated bank account created on behalf of the user to potentially complete the transfer. In these embodiments, subject to the transfer being approved, the one or more components of the gaming establishment fund management system transfer (or otherwise approve a transfer for subsequent settlement upon an occurrence of a settlement event) an amount of funds to the integrated bank account created for the user from the EGM. In these embodiments, a cashout of funds from the EGM result in a transfer of funds to the integrated bank account. For example, as seen in FIG. 4B (which illustrates the described interactions between the user interfacing with a component of the gaming establishment fund management system (e.g., a SMIB accessible via a service window), the EGM, the gaming establishment fund management system (e.g., the enterprise wallet) and the component that created the integrated bank account on behalf of the user (e.g., the enterprise electronic wallet system), certain embodiments of the present disclosure employ the gaming establishment fund management system to facilitate the transfer of funds from the EGM to the integrated bank account created on behalf of the user.

It should be appreciated that while FIGS. 4A and 4B show the gaming establishment fund management system assisted flow of funds between the integrated bank account created on behalf of the user and the EGM, the timing of such transfers may be based on the periodic settlement of funds held in one or more backing bank accounts. That is, as described below, the gaming establishment fund management system and/or the enterprise electronic wallet system determines how much funds to transfer between the integrated bank account created on behalf of the user and the gaming establishment fund management system backing bank account with such a transfer occurring upon a settlement event.

In certain embodiments, the system enables a user to transfer funds from an integrated bank account created on behalf of the user to a point-of-sale terminal of a retail establishment to facilitate a purchase of goods and/or services. In such embodiments, to employ a payment instrument, such as a debit card, to facilitate the use of funds from an integrated bank account created on behalf of the user to an account associated with a retailer to purchase goods and/or services from the retailer, the user presents the payment instrument to potentially access the funds in the integrated bank account for the purchase transaction. In different embodiments, the presented payment instrument includes a debit card taking the form of one or more of a smart debit card that stores account information, a magnetic striped debit card that stores account information, a smart debit card that does not store any account information but is associated with a debit card number that is associated with account information in one or more maintained databases, a magnetic striped debit card that does not store any account information but is associated with a debit card number that is associated with account information in one or more maintained databases, a mobile device application that stores account information, and/or a mobile device application that does not store any account information but is associated with a debit card number that is associated with account information in one or more maintained databases.

In certain such embodiments wherein the payment instrument includes a debit card presented in virtual or electronic form using a mobile device application, such as an electronic wallet that stores debit card data, the mobile device application prompts the user to cause the mobile device to engage the point-of-sale terminal, such as prompting the user to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal, wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the debit card to the point-of-sale terminal to facilitate the potential purchase of goods and/or services.

In certain embodiments, the user needs to take one or more steps to approve a transaction to access funds in an integrated bank account created on behalf of the user using an associated payment instrument. In one such embodiment, the user acknowledges the approval of accessing funds in the account using a debit card, when needed, by entering a personal identification number (“PIN”) via a mobile device application, providing a signature and/or presenting a biometric identifier to a mobile device. In another embodiment, the user acknowledges the approval of accessing funds in the account using a debit card, when needed, by entering a PIN, providing a signature and/or presenting a biometric identifier to the retail point-of-sale terminal or a peripheral device associated with the retail point-of-sale terminal.

In various embodiments, upon the presentation of the payment instrument at an applicable point-of-sale terminal of a retail point-of-sale system, the components of the systems individually or collectively determine whether or not to complete the attempted retail purchase using funds maintained in the integrated bank account created on behalf of the user. In these embodiments, upon receiving data or information regarding the payment instrument and based on the requested purchase complying with any usage controls associated with the purchase transaction, the retail point-of-sale system communicates with the enterprise electronic wallet system to request a transfer of an amount of funds to cover the cost of the intended purchase. The enterprise electronic wallet system operates with zero, one or more other components to determine if the integrated bank account created on behalf of the user has adequate funds for the intended purchase. That is, upon the requested transfer of funds to complete the retail purchase using funds in an integrated bank account created on behalf of the user, one or more components of the present disclosure operate to log a user into one or more accounts (if necessary) and determine whether to authorize the transfer of the determined amount of funds.

If the enterprise electronic wallet system indicates that the integrated bank account created on behalf of the user lacks adequate funds for the purchase, the enterprise electronic wallet system denies this sale transaction of the goods and/or services using the created account. One or more denial messages of the sale transaction of the goods and/or services using the account are communicated to the retail point-of-sale system. On the other hand, if the enterprise electronic wallet system confirms the presence of adequate funds in the integrated bank account created on behalf of the user (and, in certain instances, further confirms the inapplicability (or satisfaction) of any usage controls), the enterprise electronic wallet system authorizes the sale of the goods and/or services. The enterprise electronic wallet system then proceeds to modify a balance of the integrated bank account created on behalf of the user to reflect a debt to cover the purchased goods and/or services. In addition to accounting for the purchase price of the goods and/or services by reducing a balance of the integrated bank account created on behalf of the user, the enterprise electronic wallet system communicates one or more authorization messages of the sale transaction of the goods and/or services to the retail point-of-sale system to complete the sale of the goods and/or services. Such a completed purchase of the goods and/or services is associated with a transaction identification which one or more components of the system store for reporting purposes

It should be appreciated that while the use of a payment instrument associated with an integrated bank account created on behalf of the user to access funds includes the modification of the balance of the integrated bank account based on such access, the settlement of such funds with the retailer occurs upon a settlement event. In these embodiments, the amount to cover the purchased goods and/or services with funds in the integrated bank account created on behalf of the user are subsequently transferred, as part of a settlement process, from a backing bank account to a retailer bank account associated with the retailer. Such a settlement event occurs automatically at a preset interval or point in time, automatically in real time, and/or responsive to one or more inputs received to initiate the settlement event. In these embodiments, upon an occurrence of the settlement event, a financial institution associated with the enterprise electronic wallet system operates with a financial institution associated with the retailer to cause a transfer of an amount of funds between the integrated bank account created on behalf of the user and the financial institution account associated with the retailer. In certain such embodiments, since one or more jurisdictions require that the amount of funds associated with one or more gaming establishment accounts maintained by a gaming establishment fund management system for one or more users are secured by a corresponding amount of funds in one or more backing bank accounts for the gaming establishment and since the integrated bank account created on behalf of the user is effectively operating as the gaming establishment account for certain transactions occurring within a gaming establishment, to account for the use of funds flowing to and/or from such an integrated bank account, the system causes, either in association with each transaction or in association with a plurality of transactions, the transfer of funds between the different backing bank accounts associated with the gaming establishment and the retailer where the payment instrument was used. Such settlement transfers not only ensure that the retailer is paid for the goods and/or services purchased using the payment instrument associated with the integrated bank account (or alternative the user is credited for the refund transaction associated with the payment instrument), but such settlement transfers further ensure that the amounts maintained in the integrated bank account created on behalf of the user comply with jurisdictional requirements by corresponding with the amounts maintained in the one or more associated backing bank accounts.

In certain embodiments, to incentivize a user to access funds in an integrated bank account created on behalf of the user to make retail purchases, the system enables the user to earn gaming establishment benefits in association with such retail purchases. In these embodiments, when the system determines that the user has made a purchase using the debit card associated with the integrated bank account created on behalf of the user, the enterprise electronic wallet system notifies, in real-time or responsive to a reporting event, a component of a gaming establishment patron management system, such as a player tracking system, about the purchase activity.

In one such embodiment, the enterprise electronic wallet system determines how much to award the user for their spend, such as a specific number of points into the user's patron management loyalty account (e.g., player tracking points deposited into a player tracking account) and/or a specific amount or non-cashable credits (and/or promotional credits) to deposit into a gaming establishment account associated with the user, such as a cashless wagering account. In another such embodiment, the enterprise electronic wallet system determines a benefit taking the form of one or more plays of one or more games of an EGM, a modification to one or more game play features, and/or an addition of one or more game play features and associates that benefit with an account associated with the user.

In another embodiment, the enterprise electronic wallet system notifies the gaming establishment patron management system and/or the gaming establishment fund management system of the spend and that system calculate the amount and type of award the credit to the user. In another such embodiment, the enterprise electronic wallet system notifies the gaming establishment patron management system and/or the gaming establishment fund management system of the spend and that system determines a benefit taking the form of one or more plays of one or more games of an EGM, a modification to one or more game play features, and/or an addition of one or more game play features and associates that benefit with an account associated with the user. As such, in various embodiments, following the occurrence of an incentive triggering event associated with a purchase using funds in an integrated bank account created on behalf of the user, the system provides one or more benefits to the user.

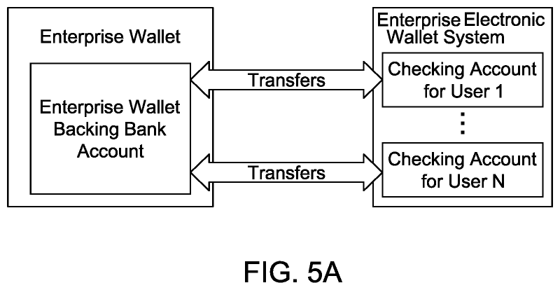

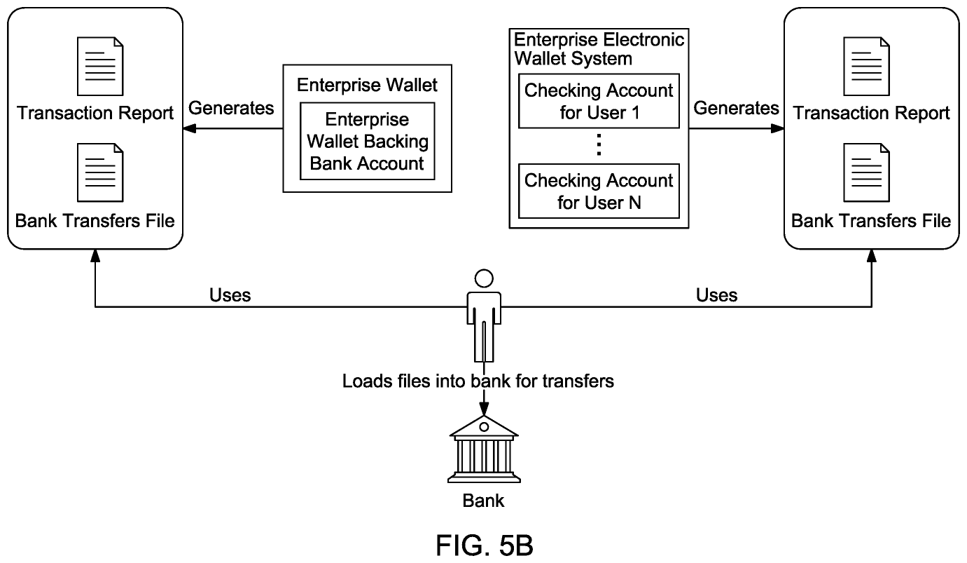

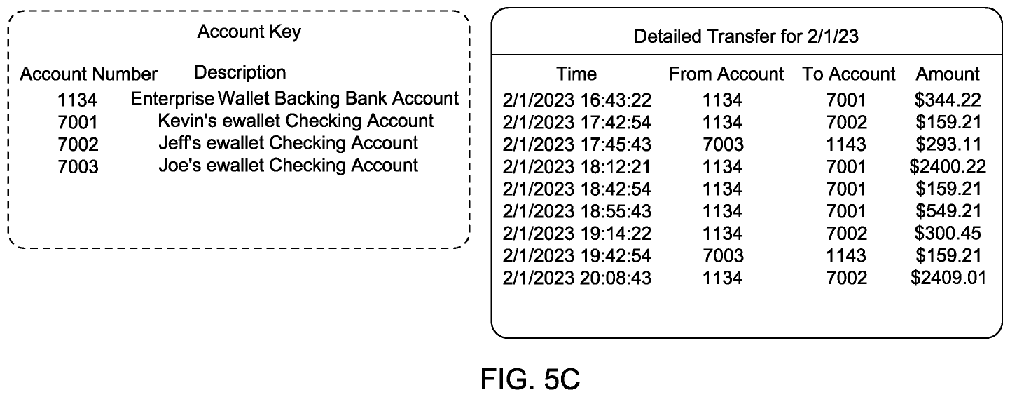

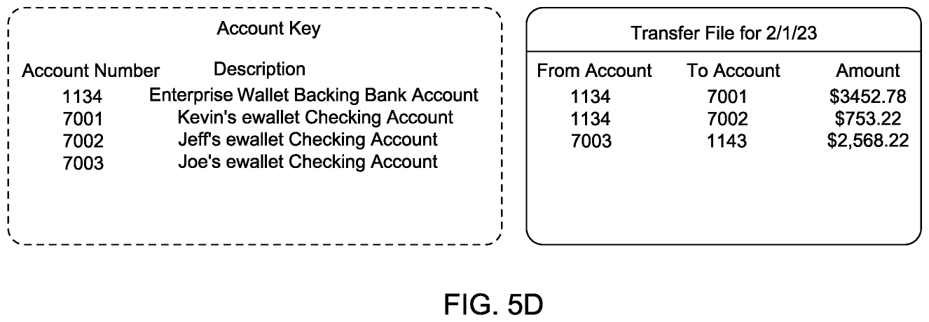

In certain embodiments, as indicated above, the enterprise electronic wallet system creates and owns a designated integrated bank account, such as a checking account, for each user and enables a transfer of fund data between this integrated bank account and one or more gaming establishment accounts associated with that user, but the transfer of actual funds between this integrated bank account and one or more gaming establishment accounts associated with that user are delayed until an occurrence of a settlement event. In these embodiments, the backing bank accounts between both systems need to be reconciled and settled periodically to ensure that users have access to the underlying funds when performing external transactions. Accordingly, one or more of the gaming establishment fund management system and/or the enterprise electronic wallet system of the present disclosure create ledgers or reports of transactions to determine the expected amount of funds that need to be transferred between the various accounts. In certain embodiments, the gaming establishment fund management system and/or the enterprise electronic wallet system employ such information from the ledgers created by the gaming establishment fund management system and/or the enterprise electronic wallet system to automatically perform the required underlying bank transfers between the various accounts. For example, as seen in FIG. 5A, the gaming establishment fund management system (e.g., the enterprise wallet) coordinates the transfer of funds amongst between the gaming establishment fund management system backing bank account (e.g., the enterprise wallet backing bank account) and the various integrated bank accounts created by the enterprise electronic wallet system on behalf of various users.

In certain embodiments, the gaming establishment fund management system and/or the enterprise electronic wallet system employ such information to direct appropriate personnel of the exact amounts to be transferred between the various accounts. For example, as seen in FIG. 5B, the gaming establishment fund management system (e.g., the enterprise wallet) and/or the enterprise electronic wallet system generate transaction reports (as seen in FIG. 5C) to direct an operator which transfers of funds to make between the gaming establishment fund management system backing bank account (e.g., the enterprise wallet backing bank account) and the various integrated bank accounts created by the enterprise electronic wallet system on behalf of various users. As further seen in FIG. 5B, the gaming establishment fund management system (e.g., the enterprise wallet) and/or the enterprise electronic wallet system generate bank transfer files (as seen in FIG. 5D) that can be imported or otherwise consumed by the bank to settle the various accounts upon the occurrence of a settlement event, such as at the end of a day.

In certain embodiments, appropriate personnel could choose to leverage files provided by the gaming establishment fund management system or the enterprise electronic wallet system. In certain other embodiments, appropriate personnel reconciles the files produced by both the gaming establishment fund management system and/or the enterprise electronic wallet system before performing the bank transfer using the transfers file produced by one system. Such a process enables appropriate personnel (and/or an automated system) to catch or identify scenarios where the gaming establishment fund management system and the enterprise electronic wallet system have conflicting data regarding how much money should be transferred between the backing bank accounts. It should be appreciated that while illustrated in FIG. 5B as the backing bank account used by gaming establishment fund management system being the same bank as the backing back accounts created and managed for each user, the gaming establishment fund management system backing bank account could be at a separate bank from the bank at which the user integrated bank accounts are created at that are associated with the enterprise electronic wallet system.

As evidenced by the various embodiments described, the system of the present disclosure provides a user instant access outside of a gaming establishment to funds that would otherwise reside in a gaming establishment account for gaming purposes by creating and integrating a bank account with a gaming establishment account maintained for that user. Such a configuration enables funds to be accessed both at gaming establishment verticals and non-gaming establishment verticals without the need to wait for any extended periods of time for fund transfers from a gaming establishment account to an external financial institution account to be completed (or alternatively pay various surcharge fees to expedite such fund transfers). That is, unlike prior payment solutions in which if a user wants to access their funds held in a casino account at a retail establishment outside of the casino, the user needs to first transfer their funds to an external bank account (after which the user can then pay at that retail establishment outside of the casino using a debit card or credit card associated with their external bank account), or alternatively first transfer their funds to an external electronic wallet (after which the user can use a pre-paid debit card associated with their external electronic wallet to pay at that retail establishment outside of the casino), the creation of the integrated bank account in association with the system of the present disclosure enables a user to avail themselves of the use of a payment instrument, such as a debit card, for purchases made outside of the casino while still having funds readily available for use within the casino. Accordingly, in certain embodiments, the system of the present disclosure enables the balance of the user's gaming establishment account to be transferred, upon a funding event, to an integrated bank account (that is dedicated to the user and remains owned by the system of the present disclosure) such that funds that previously were not immediately accessible outside of the casino become accessible via a payment instrument associated with the integrated bank account. By integrating a bank account created in association with the system directly with one or more gaming establishment accounts, the present disclosure enables a payment instrument associated with the integrated bank account to function as an interface to access funds independent of any involvement of any other external accounts that require a relatively extended period of time to transfer funds to. Such a configuration thus enables a user to access the network payment processors accessible with certain payment instruments, such as debit cards, without first needing to transfer any amounts of funds from a gaming establishment account to an external account associated with the debit card to gain such access. Such a configuration additionally saves users time (e.g., no time needs to be spent transferring funds from a gaming establishment account to an external banking account associated with a debit card or waiting a dedicated amount of time for such a transfer to be completed) and offers operational efficiencies (e.g., reducing the number of touchpoints funds must flow through before they may be used) compared to prior payment solutions involving funds in a casino account.

Accordingly, in view of the different channels of commerce available both in association with and independent of one or more gaming establishments, the system offers an integrated bank account created in association with the system that enables access to funds in different channels of commerce associated with or independent of one or more gaming establishments. Such transfers thus reduce the fund movement friction encountered in using funds otherwise held in a gaming establishment account to complete transactions outside of the gaming establishment network while still realizing the benefits of network payment processors offered by the use of payment instruments associated with the integrated bank account. Such a configuration further facilitates, amongst other benefits, a more cashless environment (e.g., cash does not need to be withdrawn from a gaming establishment account and then brought to a retailer, either internal to or external from the gaming establishment, to purchase goods and/or services) which increases safety (e.g., minimizing users having to carry large sums of cash associated with large sums of money and minimizing such cash being a vehicle to spread potentially harmful contagions).

It should be appreciated that the electronic fund data transfers of the present disclosure may occur in addition to or as an alternative from cash-based fund transfers and/or ticket voucher-based fund transfers. In one such embodiment, an amount of funds transacted against is funded via any of an electronic fund transfer, a cash-based fund transfer or a ticket voucher-based fund transfer. In another embodiment, an amount of funds transacted against is funded via an electronic fund transfer or a cash-based fund transfer (but is not funded via any ticket voucher-based fund transfer). In another embodiment, an amount of funds transacted against is funded via an electronic fund transfer or a ticket voucher-based fund transfer (but is not funded via any cash-based fund transfer). In another embodiment, an amount of funds transacted against is funded via an electronic fund transfer (but is not funded via a cash-based fund transfer nor a ticket voucher-based fund transfer).

It should be further appreciated that any functionality or process of the present disclosure may be implemented via one or more servers (associated with or independent of any component of any system disclosed herein), one or more non-gaming establishment devices (e.g., a point-of-sale terminal of a retailer located external to and independent of a gaming establishment), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment management system supported by or otherwise located inside a gaming establishment device and/or a non-gaming establishment device). Accordingly: (i) while certain functions, features or processes are described herein as being performed by a non-gaming establishment device, such functions, features or processes may alternatively be performed by one or more servers, or one or more mobile device applications, one or more gaming establishment devices, and/or one or more gaming establishment components, and (ii) while certain functions, features or processes are described herein as being performed by one or more servers (e.g., a server of an enterprise electronic wallet system, a server of a gaming establishment fund management system and/or a server of a retail point-of-sale system), such functions, features or processes may alternatively be performed by one or more gaming establishment devices, one or more components of a gaming establishment system, one or more non-gaming establishment devices, one or more mobile device applications, or one or more gaming establishment components.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of an enterprise electronic wallet system; zero, one or more components of a gaming establishment patron management system; zero, one or more components of a retail point-of-sale system; and/or zero, one or more gaming establishment devices. In these embodiments, such components of the gaming establishment fund management system, the enterprise electronic wallet system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the enterprise electronic wallet system, the component of the retail point-of-sale system and/or the gaming establishment device; (3) accessing memory to configure or reconfigure parameters in the memory according to indicia read from the component of the gaming establishment fund management system, the component of the enterprise electronic wallet system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the enterprise electronic wallet system, the component of the retail point-of-sale system and/or the gaming establishment device, while in other embodiments, at least one component of the controller resides outside of the housing of the component of the gaming establishment fund management system, the component of the enterprise electronic wallet system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the enterprise electronic wallet system, the component of the retail point-of-sale system and/or the gaming establishment device disclosed herein. In certain embodiments, the at least one memory device resides within the housing of the component of the gaming establishment fund management system, the component of the enterprise electronic wallet system, the component of the retail point-of-sale system and/or the gaming establishment device, while in other embodiments at least one component of the at least one memory device resides outside of the housing of the component of the gaming establishment fund management system, the component of the enterprise electronic wallet system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the enterprise electronic wallet system, the component of the retail point-of-sale system and/or the gaming establishment device; (2) associations between configuration indicia read from the component of the gaming establishment fund management system, the component of the enterprise electronic wallet system, the component of the retail point-of-sale system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the enterprise electronic wallet system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the enterprise electronic wallet system, the component of the retail point-of-sale system and/or the gaming establishment device to control the component of the gaming establishment fund management system, the component of the enterprise electronic wallet system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the enterprise electronic wallet system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the enterprise electronic wallet system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the enterprise electronic wallet system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the enterprise electronic wallet system, the component of the retail point-of-sale system and/or the gaming establishment device loads the new device driver from the at least one memory device to enable communication with the new device. For instance, one type of card reader in the component of the gaming establishment fund management system, the component of the enterprise electronic wallet system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the enterprise electronic wallet system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the enterprise electronic wallet system, the component of the retail point-of-sale system and/or the gaming establishment device. In various embodiments, the display devices serve as digital glass configured to aspects of the gaming establishment in which the component of the gaming establishment fund management system, the component of the enterprise electronic wallet system, the component of the retail point-of-sale system and/or the gaming establishment device is located. In various embodiments, the component of the gaming establishment fund management system, the component of the enterprise electronic wallet system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the enterprise electronic wallet system, the component of the retail point-of-sale system and/or the gaming establishment device receives an actuation, the component of the gaming establishment fund management system, the component of the enterprise electronic wallet system, the component of the retail point-of-sale system and/or the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the enterprise electronic wallet system, the component of the retail point-of-sale system and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the enterprise electronic wallet system, the component of the retail point-of-sale system and/or the gaming establishment device. In certain embodiments, the component of the gaming establishment fund management system, the component of the enterprise electronic wallet system, the component of the retail point-of-sale system and/or the gaming establishment device displays a sequence of audio and/or visual attraction messages during idle periods to attract potential users to the component of the gaming establishment fund management system, the component of the enterprise electronic wallet system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the enterprise electronic wallet system, the component of the retail point-of-sale system and/or the gaming establishment device. In one embodiment, the at least one input device includes a payment device configured to communicate with the at least one processor of the component of the gaming establishment fund management system, the component of the enterprise electronic wallet system, the component of the retail point-of-sale system and/or the gaming establishment device to fund the component of the gaming establishment fund management system, the component of the enterprise electronic wallet system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the enterprise electronic wallet system, the component of the retail point-of-sale system and/or the gaming establishment device to be funded via an electronic funds transfer, such as a transfer of funds from a bank account. In another embodiment, the component of the gaming establishment fund management system, the component of the enterprise electronic wallet system, the component of the retail point-of-sale system and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the enterprise electronic wallet system, the component of the retail point-of-sale system and/or the gaming establishment device. When the component of the gaming establishment fund management system, the component of the enterprise electronic wallet system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the enterprise electronic wallet system, the component of the retail point-of-sale system and/or the gaming establishment device operator to, when actuated, cause the component of the gaming establishment fund management system, the component of the enterprise electronic wallet system, the component of the retail point-of-sale system and/or the gaming establishment device to perform particular functions. For instance, such buttons may be hard keys, programmable soft keys, or icons icon displayed on a display device of the component of the gaming establishment fund management system, the component of the enterprise electronic wallet system, the component of the retail point-of-sale system and/or the gaming establishment device that are actuatable via a touch screen of the component of the gaming establishment fund management system, the component of the enterprise electronic wallet system, the component of the retail point-of-sale system and/or the gaming establishment device or via use of a suitable input device of the component of the gaming establishment fund management system, the component of the enterprise electronic wallet system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the enterprise electronic wallet system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the enterprise electronic wallet system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the enterprise electronic wallet system, the component of the retail point-of-sale system and/or the gaming establishment device, such as one or more rechargeable power sources (e.g., rechargeable batteries) located at the component of the gaming establishment fund management system, the component of the enterprise electronic wallet system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the enterprise electronic wallet system, the component of the retail point-of-sale system and/or the gaming establishment device; detecting the presence and/or identity of various persons (e.g., users, casino employees, etc.), devices (e.g., user input devices), and/or systems within a predetermined proximity to the component of the gaming establishment fund management system, the component of the enterprise electronic wallet system, the component of the retail point-of-sale system and/or the gaming establishment device.

The at least one data preservation component is configured to detect or sense one or more events and/or conditions that, for example, may result in damage to the component of the gaming establishment fund management system, the component of the enterprise electronic wallet system, the component of the retail point-of-sale system and/or the gaming establishment device and/or that may result in loss of information associated with the component of the gaming establishment fund management system, the component of the enterprise electronic wallet system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the enterprise electronic wallet system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the enterprise electronic wallet system, the component of the retail point-of-sale system and/or the gaming establishment device. For example, in one implementation, the at least one geolocation module is configured to receive GPS signal information for use in determining the position or location of the component of the gaming establishment fund management system, the component of the enterprise electronic wallet system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the enterprise electronic wallet system, the component of the retail point-of-sale system and/or the gaming establishment device.

The at least one user identification module is configured to determine the identity of the current user or current owner of the component of the gaming establishment fund management system, the component of the enterprise electronic wallet system, the component of the retail point-of-sale system and/or the gaming establishment device. For example, in one embodiment, the current user is required to perform a login process at the component of the gaming establishment fund management system, the component of the enterprise electronic wallet system, the component of the retail point-of-sale system and/or the gaming establishment device in order to access one or more features. Alternatively, the component of the gaming establishment fund management system, the component of the enterprise electronic wallet system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the enterprise electronic wallet system, the component of the retail point-of-sale system and/or the gaming establishment device that is used to determine the identity of the current user. In at least one embodiment, various security features are incorporated into the component of the gaming establishment fund management system, the component of the enterprise electronic wallet system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the enterprise electronic wallet system, the component of the retail point-of-sale system and/or the gaming establishment device.

In various embodiments, the component of the gaming establishment fund management system, the component of the enterprise electronic wallet system, the component of the retail point-of-sale system and/or the gaming establishment device includes a plurality of communication ports configured to enable the at least one processor of the component of the gaming establishment fund management system, the component of the enterprise electronic wallet system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the enterprise electronic wallet system, the component of the retail point-of-sale system and/or the gaming establishment device has a support structure, housing, or cabinet that provides support for a plurality of the input devices and the output devices of the component of the gaming establishment fund management system, the component of the enterprise electronic wallet system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/of” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to a receipt, from a component of a banking institution, of data associated with an authorized purchase transaction at a point-of-sale terminal using an amount of funds maintained in an integrated bank account associated with a user, cause the processor to:
determine a gaming establishment account associated with the user, and
communicate, to a component of a gaming establishment system that maintains the gaming establishment account, data associated with the authorized purchase transaction, wherein the communicated data results in a benefit being associated with the gaming establishment account.

2. The system of claim 1, wherein the gaming establishment account comprises a player tracking account.

3. The system of claim 2, wherein the benefit comprises a quantity of player tracking points.

4. The system of claim 1, wherein the gaming establishment account comprises a cashless wagering account.

5. The system of claim 4, wherein the benefit comprises at least one of a quantity of non-cashable credits and a quantity of promotional credits.

6. The system of claim 1, wherein the communicated data associated with the authorized purchase transaction comprises the benefit to be associated with the gaming establishment account.

7. The system of claim 1, where the purchase transaction is initiated in association with a debit card associated with the integrated bank account.

8. The system of claim 1, wherein a transfer of an amount of funds associated with the purchase transaction occurs responsive to a settlement event.

9. The system of claim 1, wherein the point-of-sale terminal comprises a non-gaming establishment retail point-of-sale terminal.

10. A system comprising:
a processor; and
a memory device that stores a plurality of instructions that, when executed by the processor responsive to a receipt, from a component of a banking institution, of data associated with an authorized purchase transaction initiated in association with a debit card associated with a checking account linked to a gaming establishment account, cause the processor to:
determine a benefit associated with the authorized purchase transaction, and
communicate, to a component of a gaming establishment system that maintains the gaming establishment account, data associated with the determined benefit.

11. The system of claim 10, wherein the gaming establishment account comprises a player tracking account and the benefit comprises a quantity of player tracking points credited to the player tracking account.

12. A method of operating a system, the method comprising:
responsive to a receipt, from a component of a banking institution, of data associated with an authorized purchase transaction at a point-of-sale terminal using an amount of funds maintained in an integrated bank account associated with a user:
determining, by a processor, a gaming establishment account associated with the user, and
communicating, to a component of a gaming establishment system that maintains the gaming establishment account, data associated with the authorized purchase transaction, wherein the communicated data results in a benefit being associated with the gaming establishment account.

13. The method of claim 12, wherein the gaming establishment account comprises a player tracking account.

14. The method of claim 13, wherein the benefit comprises a quantity of player tracking points.

15. The method of claim 12, wherein the gaming establishment account comprises a cashless wagering account.

16. The method of claim 15, wherein the benefit comprises at least one of a quantity of non-cashable credits and a quantity of promotional credits.

17. The method of claim 12, wherein the communicated data associated with the authorized purchase transaction comprises the benefit to be associated with the gaming establishment account.

18. The method of claim 12, where the purchase transaction is initiated in association with a debit card associated with the integrated bank account.

19. The method of claim 12, wherein a transfer of an amount of funds associated with the purchase transaction occurs responsive to a settlement event.

20. The method of claim 12, wherein the point-of-sale terminal comprises a non-gaming establishment retail point-of-sale terminal.
